(19) United States
(12) Patent Application Publication
(10) Pub. No.: US 2008/0076469 A1
(43) Pub. Date: Mar. 27, 2008

(54) Method and Mobile Communication Terminal for Playing Multimedia Content

(75) Inventors: Seong-Hun Shin, Seoul (KR); Sang-Bum Kim, Seoul (KR); Jeong-Ho Lee, Gyeonggi-do (JP); Young-Hoo Koh, Seoul (KR)

Correspondence Address: CANTOR COLBURN, LLP, 20 Church Street, 22nd Floor, Hartford, CT, 06103, US

(73) Assignee: NEOMTEL CO., LTD., Seoul (KR)

(21) Appl. No.: 11/576,920

(22) PCT Filed: Oct. 6, 2005
(86) PCT No.: PCT/KR05/03296

§ 371 Date: Apr. 9, 2007

(30) Foreign Application Priority Data
Oct. 8, 2004 (KR) 10-2004-0080525

(51) Int. Cl. H04M 1/00

(52) U.S. Cl. 455/556.1; 455/566

(57) ABSTRACT

Users desire to add their own produced images to multimedia content, or to update the multimedia content. However, there is a problem in that conventional multimedia content cannot be changed. A mobile communication terminal according to the present invention monitors an occurrence of an event, changes at least one of elements of a played content file to a new element when the event occurs, and plays the content file including the changed element by means of a playback unit. The new element to be changed may be an element received from a storage medium connected on a network, a new file stored in a memory unit, or an image taken by a camera module.

### TECHNICAL FIELD

The present invention relates to a mobile communication terminal that plays multimedia content and, more particularly, to a mobile communication terminal that plays multimedia content for the mobile communication terminal, which is produced in a standardized format, through a standard playback engine incorporated in the mobile communication terminal.

### BACKGROUND ART

The present applicant has provided standardized contents for standby screens of mobile communication terminals and has filed a plurality of patent applications, i.e., Korean Patent Application Nos. 2000-42840 and 2000-79982. Recently, the present applicant has also filed Korean Patent Application No. 2003-14687 on Mar. 10, 2003 (Korean Patent Publication No. 2003-87525, disclosed on Nov. 14, 2003), which relates to a technology for providing interactive multimedia content on a standby screen.

The above-mentioned publication discloses a technology for providing interactive content by checking and performing commands issued by a user whenever each frame of the content for a standby mode is played back. In order to respond to the user's command, keys are first acquired from a key input queue. Next, it is determined whether or not there is an action which corresponds to the acquired key and is previously defined as part of the content. If the action exists, the action is carried out. Examples of the action include controls related to playing back the content, such as jump, repetitive play, fast play or rewind, a vibration command, a sound output command, and the like.

However, in the above-mentioned prior art, there is a problem in that it is not possible to change multimedia contents. Users desire to add their own produced images to the existing content, or to update the existing content.

### DISCLOSURE OF INVENTION

### Technical Solution

It is an object of the present invention to provide a mobile communication terminal that plays content that can change.

It is another object of the present invention to diversify functions of content played in a mobile communication terminal.

### Advantageous Effects

Since a mobile communication terminal according to the present invention can update part of or the entire content through a network, the mobile communication terminal can provide various contents.

In addition, users can produce their own contents using multimedia function such as a camera module of the mobile communication terminal.

Further, content providers can produce and provide various contents since the contents can be updated.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mobile communication terminal according to an embodiment of the present invention;

FIG. 2 is a flow chart of a method of playing back content according to another embodiment of the present invention;

FIG. 3 is a flow chart of an embodiment of operation S107; and

FIG. 4 is a flow chart of another embodiment of operation S107.

### BEST MODE FOR CARRYING OUT THE INVENTION

According to an aspect of the present invention, there is provided a mobile communication terminal that monitors an occurrence of an event, changes at least one of elements of a content file to a new element when the event occurs, and plays the changed element of the content file.

Accordingly, it is possible to update part of or the entire content regardless of whether the content file is played or not.

According to another aspect of the present invention, there is provided a mobile communication terminal that accesses to a network resource, receives and updates a corresponding content or a corresponding element of the content.

Accordingly, it is possible to change the existing content to a new content which is provided by content providers. For example, if information concerning weather forecast, which is updated at regular intervals, is received through a network, it is possible to provide updated information concerning the weather forecast at regular intervals through the same weather forecast content.

According to another aspect of the present invention, there is provided a mobile communication terminal capable of changing a corresponding content or a corresponding element of the content to an image or a moving image inputted from a camera module incorporated in the mobile communication terminal.

Accordingly, users can change the existing content to an image or a moving image taken by the camera module. For example, after a user downloads a photo which is taken of a star performer and a companion, the user can substitute the companion of the downloaded photo by his/her own photo.

### MODE FOR THE INVENTION

Exemplary embodiments in accordance with the present invention will now be described in detail with reference to the accompanying drawings.

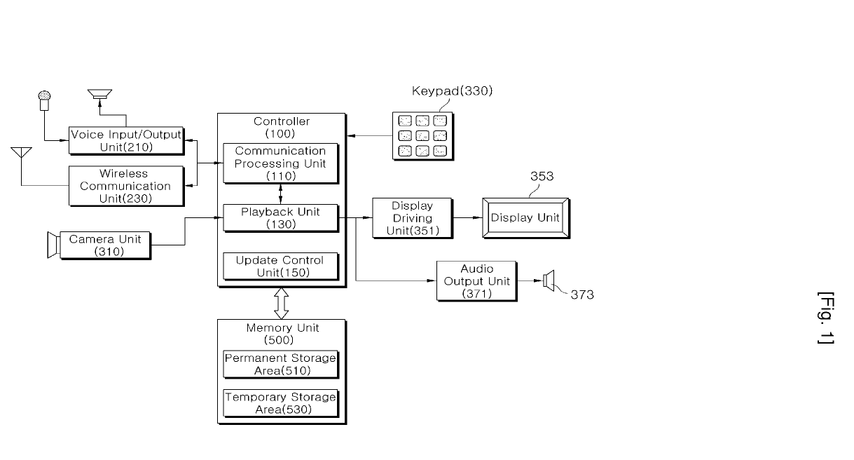

FIG. 1 is a block diagram of a mobile communication terminal according to an embodiment of the present invention. The mobile communication terminal includes a communication processing unit 110, a playback unit 130, an update control unit 150, a voice input/output unit 210, a wireless communication unit 230, a keypad 330, a display unit 353, an audio output unit 371, and a memory unit 500. The wireless communication unit 230 transmits/receives voice and data signals through a mobile communication network. The communication processing unit 110 processes the voice and data signals transmitted/received through the wireless communication unit 230. The voice input/output unit 210 converts the voice signal processed by the communication processing unit 110 into an audible sound, or converts a voice signal inputted from the outside and transmits it to the communication processing unit 110. The memory unit 500 stores content data. The playback unit 130 checks whether or not elements of content to be played are present in a permanent storage area 510 of the memory unit 500, loads the elements into a temporary storage area 530 of the memory unit 500, and, if there are updated elements, loads the updated elements into the temporary storage area 530. The display unit 353 displays images played back in the playback unit 130. The audio output unit 371 outputs audio signals played back in the playback unit 130. The update control unit 150 is operated when the playback unit 130 is activated, monitors whether or not an event occurs, changes at least one of the elements of the content file to be played to a new element when the event occurs, and notifies the playback unit 130 that the elements have been updated.

The wireless communication unit 230 includes an antenna and a radio frequency (RF) circuit to communicate with base stations. The voice input/output circuit 210 transfers received voice to a user, converts a user's voice which is input from a microphone, and converts digital voice data into an analog voice signal and vice versa. The voice input/output circuit 210 includes an audio amplifier, a filter, or the like.

The keypad 330 allows a user to enter data. Examples of the keypad 330 include a key button of a mobile communication terminal and a touch panel of a personal digital assistant (PDA). The display unit 353 may be a liquid crystal display (LCD) device. Image data outputted from the playback unit 130 is processed in the display driving unit 351 and converted into an analog signal for driving the display unit 353. The term display unit may refer to a device including a display driving unit or the like.

The audio output unit 371 converts the audio signal played by and outputted from the playback unit 130 into an audio signal and outputs the audio signal through a speaker 373. The audio output unit 371 includes a digital/analog converter, an amplifier, or the like.

The camera unit 500 converts an optical signal inputted from a lens system into an electrical signal through an image pickup device. Currently, a camera module for a mobile communication terminal converts an electrical signal into a digital image signal. The memory unit 500 may be composed of a single or a plurality of memory modules. The permanent storage area 510 may be a non-volatile memory, such as a read-only memory (ROM). The temporary storage area 530 may be a volatile memory, such as a random access memory (RAM). Both of them 510 and 530 may be provided as a single flash memory.

The communication processing unit 110 decodes a signal received from the wireless communication unit 230 into digital voice/non-voice data, or vice versa. A baseband circuit of the wireless communication unit 230 and most circuits of the controller 100 are integrated into a commercially available IC chip. The IC chip includes hardware for communication processing, a digital signal processor, and a general-purpose microprocessor.

The playback unit 130 includes a playback engine for playing content, and a content file which is executed by the playback engine. The playback engine is incorporated in the mobile communication terminal, and reads the content stored in the permanent storage area 510 of the memory unit 500 into the temporary storage area 530 and plays the content.

The content stored in the permanent storage area 510 includes a header, which includes summary information concerning the content, object files, which are elements of the content to be played, and a playback control command. Examples of the object files include image files, sound files, or moving image files. The playback engine of the playback unit 130 reads a content file from the permanent storage area 510 of the memory unit 500 into the temporary storage area 530, loads the object files from the information included in the header into a resource area, reads the playback control command into an action area, sequentially reads and plays the object files loaded in the resource area according to the playback control command stored in the action area, and, when the content is updated, loads the updated file into the temporary storage area and plays the updated file. The term “action in the present invention implies a sequence of playback control commands which constitute a single operation. Accordingly, when one of the object files constituting original content changes to another file, which has the same file name as but different data than an original file, and is stored in the permanent storage area 510, the changed content is played back afterwards.

For example, the playback control commands control a display order of a series of frames, or a delay time of the series of frames, and define content to be displayed in each frame. The respective frames may be displayed by overlapping images of a plurality of layers with transparent margins on a background image. In addition to the images, sounds can be also controlled in synchronization with playback of each frame. Accordingly, it is possible to produce various multimedia contents by combining the playback control commands and the object files.

The update control unit 150 operates according to part of the playback control command included in the content. When the update control unit 150 detects an occurrence of an event, it updates the content to be played, or at least one of object files which constitute the content file, and notifies the playback unit 130 that the content has been updated.

In one embodiment, the update control unit 150 may be a routine executed as an independent thread which is operated when the playback unit 130 is activated. The update control unit 150 updates the object and notifies the playback unit 130 that the content has been updated. The playback unit 130 reads the updated object file or the content file from the permanent storage area 510 into the temporary storage area 530, and plays the updated content. Accordingly, it is possible to change and play the content while the content is played. The update control unit 150 manages a script which defines a definition of an event and an action corresponding to the defined event, and monitors an occurrence of the defined event. When the event occurs, the update control unit 150 executes an action which corresponds to the event.

In another embodiment, the update control unit 150 may be a conceptual expression of playback control commands which are distributed in the playback unit 130. That is, among the playback control commands, a command to generate a frame and/or a command to output the generated frame includes a definition of an event which causes execution of a script that defines a specified action. For example, when a ‘SEND’ button of a mobile phone is pushed while the playback engine is playing a specified content, a command to generate a frame executes a predetermined script in response to this event. The script may be configured to update part of an object of the content which is currently played through a network.

The playback control command may include information concerning addresses of network resources that provide content to be updated. The update control unit 150 may access the network resource through the wireless communication unit 230 under the control of the playback control command, receive and update the content or object files that constitute the content.

An example of the script is described as follows:

ext_importMovie(“http://211.233.24.178/vis20Dm/files/photones1.vis”, “newm”, “loading”, “nerror”);

ext_replaceMovieClip(“oldm”, “newm”)

ext_saveResource(“newm”)

The function ext_importMovie( ) is a function of receiving a file from a network and making it a movie clip symbol. The function ext_replaceMovieClip( ) is a function of replacing an existing movie clip with the movie clip symbol received from the network. The function ext_saveResource( ) is a function of storing the movie clip symbol in the permanent storage area 510, and allowing the updated movie clip information to be played. When the function ext_importMovie( ) is executed, a mobile communication terminal requests and receives a corresponding file from URL, which is defined in a parameter, using the HTTP protocol. If the replaced movie clip information is not stored in the permanent storage area 510, the content, which is not updated and is stored in the permanent storage area 510, will be played back.

The update control unit 150 may change the content or its elements to an image or a moving image inputted from the camera unit 310 under the control of the playback control commands.

The image taken by the camera unit 310 can substitute a specified object in a frame currently played. For example, suppose that a content is composed of ten frames each of which consists of a background layer, a first layer which is a photo of a star performer, a second layer which is a photo of his/her companion, and a third layer which is a photo of clothes and accessories of the companion. In this case, if the background layer has a fixed image, and the reference positions of the remaining first, second, and third layers are changed when the first, second, and third layers displayed, images displayed in a total of ten frames can be changed to a photo taken of the user and the star performer by substituting a file of the second layer with a user's own image file taken by the user's camera. Also, the updated image needs to be stored in the permanent storage area 510 to play the updated content afterwards.

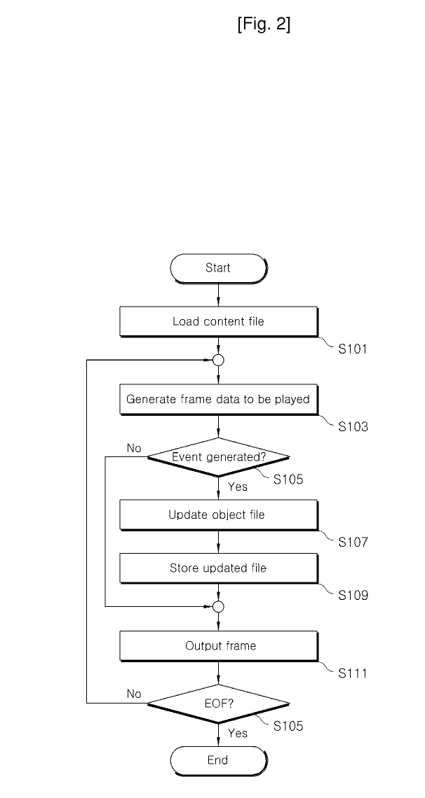

A method of playing multimedia content in a mobile communication terminal according to another embodiment of the present invention will now be described in detail with reference to FIG. 2. FIG. 2 is a flow chart of a method of playing content according to another embodiment of the present invention. The method includes the operations of sequentially reading object files included in a content file according to playback control commands included in the content file (operation S101), generating frame data to be played (operation S103), checking whether or not an event configured to update content occurs (operation S105), updating at least one of elements included in the content file if the event occurs (operation S107), and outputting the generated frame data (operation S111).

The content file includes a header which has summary information concerning the content, object files which are elements of the multimedia content to be updated, and a playback control command. Each object file may be at least one of image files, sound files, and moving image files. The content files may be recorded on a storage unit such as a ROM or a hard disk of a host computer, and may be transferred through a network. The content file may be compressed into a single file to reduce the file size. The present invention includes a recording medium that stores the content thus configured.

The playback unit 130 reads the content file stored in the permanent storage area 510 of the memory unit into a temporary storage area. When a file is compressed and stored, an operation of decompressing the compressed file may be added before reading the compressed file. The playback unit 130 loads the object files from information included in the header into a resource area, and reads the playback control command into an action area (operation S101).

Next, the playback unit 130 sequentially reads the object files loaded into the resource area according to the playback control command stored in the action area and generates frame data to be played (operation S103). In order to play a single frame, a plurality of object files, such as a plurality of image files, which constitute a plurality of layers of each frame, and a sound file, which is played in synchronization with the frame, may be related. The update control unit 150 checks a queue in which events are stored, and checks whether or not there is an action defined in connection with the currently generated event (operation S105). For example, the update control unit 150 checks a keypad queue to check whether or not there is an action defined with respect to a single key or a set of keys.

If there is a corresponding action, the corresponding content or at least one of the elements of the content file stored in the resource area is changed to a new element under the control of the playback control command included in the action (operation S107). In this case, the element preferably has the same file name as but different data than the existing element since it is not necessary to change the playback control command. In this operation, the content stored in the temporary storage area 530 of the memory unit 500 is updated. Subsequently, the playback unit 130 outputs the frame data which is previously generated (operation S111). The update operation of the update control unit 150 that is performed by checking the event queue and processing the corresponding action is preferably performed before and/or after each frame is generated since the frames are frequently output at regular speeds. If there is no defined action with respect to a combination of possible events in a current event queue, it proceeds to a frame generating operation without the above-mentioned action (operation S111).

After the operation d), operation S109 is further included in which an element of the updated content file substitutes corresponding content or an element of the content stored in the permanent storage area 510 of the memory unit 500. Accordingly, when the playback engine is terminated and restarted, the updated content is loaded and played back. The playback unit 130 checks the playback control commands. If the playback operation of the content file is not completely terminated, it returns to the operation 103 to generate next frame data. If terminated, the process is terminated (operation S105).

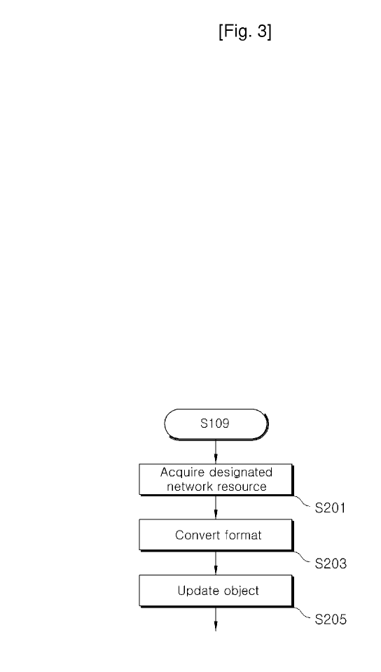

FIG. 3 is an embodiment of operation S107 according to the present invention. When a corresponding event occurs, the update control unit 150 changes at least one of elements of the corresponding content file to a file received by accessing address information of the network resource included in the playback control command. That is, when there is a corresponding action, the corresponding content or at least one of elements of the corresponding content is received by accessing the corresponding resource from the address information of the network resource included in the playback control command (operation S201). In addition, the received file may be subjected to decompression, scaling, or format conversion operation (operation S203). Subsequently, the converted object file or content file substitutes the corresponding existing object file or content file which is loaded into the temporary storage area 530 (operation S205).

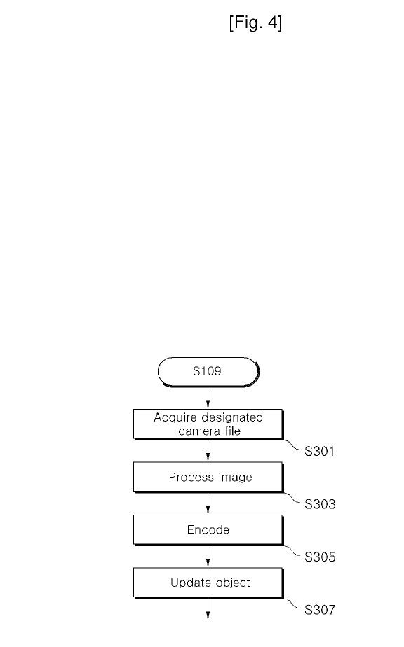

FIG. 4 is another embodiment of operation S107 according to the present invention. In the present embodiment, when the corresponding event occurs, the update control unit 150 changes at least one of elements of the corresponding content file to an image or a moving image inputted from a camera unit incorporated in a mobile communication terminal. That is, when there is a corresponding action, an image or a moving image inputted from the camera unit is acquired (operation S301). Only a part of the image or moving image, which is required for the content, is extracted and processed to have a suitable image format (operation S303). For example, if an object file for a facial part is required, the facial part is extracted from a photo and the remaining part is processed to be transparent. At this time, image processes, such as zooming, brightness or contrast control, may be added. The processes may be performed automatically or manually by a user. The processed image is encoded to a format which is compatible with the content according to the present invention (operation S305). The mobile communication terminal is preferably equipped with an encoder. The encoded object file or content file substitutes the corresponding object file or content file loaded in an existing temporary storage area 530 (operation S307).

### INDUSTRIAL APPLICABILITY

The present invention can be applied to a mobile communication field in which a mobile communication terminal plays multimedia content for the mobile communication terminal, which is produced in a standardized format, through a standard playback engine incorporated in the mobile communication terminal.

1. A mobile communication terminal which plays multimedia content, comprising:
a wireless communication unit that transmits/receives voice and data signals through a mobile communication network;
a communication processing unit that processes the voice and data signals transmitted/received through the wireless communication unit;
a voice input/output unit which converts the voice signal processed by the communication processing unit into an audible sound, or which converts a voice signal inputted from the outside and outputs the converted voice signal to the communication processing unit;
a memory unit that stores the content;
a playback unit which checks whether or not elements of content to be played are present in a permanent storage area of the memory unit, loads the elements into a temporary storage area of the memory unit, and, if there is an updated element, loads the updated element into the temporary storage area and plays the updated element;
a display unit that displays an image played by the playback unit;
an audio output unit that outputs an audio signal played by the playback unit; and
an update control unit which is operated upon activation of the playback unit, monitors an occurrence of an event, changes at least one of elements of a played content file to a new element when the event occurs, and notifies the playback unit that the element has been changed.

2. The mobile communication terminal of claim 1, wherein the content comprises:
a header including summary information of the content;
object files which are elements of multimedia content to be played; and
a playback control command.

3. The mobile communication terminal of claim 2, wherein each of the object files is an image file, a sound file, or a moving image file.

4. The mobile communication terminal of claim 1, wherein the playback control command includes address information of a network resource that provides content to be updated, and the update control unit accesses the network resource through the wireless communication unit to receive and update a corresponding content or a corresponding element under the control of the playback control command.

5. The mobile communication terminal of claim 1, further comprising a camera unit,
wherein the update control unit changes the content or the element to an image or a moving image inputted from the camera unit under the control of playback control command.

6. A mobile communication terminal which plays multimedia content, comprising:
a playback unit which reads from a permanent storage area a content file including a header having summary information of content, object files which are elements of the content to be played, and a playback control command, the object files being loaded into a resource area from the information included in the header, the playback control command being read in an action area, the object files loaded into the resource area being sequentially read and played according to the playback control command stored in the action area, and, if the content is updated, at least an updated file being loaded into a temporary storage area and being played; and
an update control unit which starts to operate upon activation of the playback unit, is defined by part of the playback control command included in the content, monitors an occurrence of an event, changes a played content or at least one of object files constituting the corresponding content file to a new element when the event occurs, and notifies the playback unit that the content has been changed.

7. The mobile communication terminal of claim 6, wherein the playback control command includes address information of a network resource that provides content to be updated, and the update control unit accesses the network resource through the wireless communication unit to receive and update a corresponding content or a corresponding object file under the control of the playback control command.

8. The mobile communication terminal of claim 6, further comprising a camera unit which takes an image or a moving image,
wherein the update control unit changes the content or the object file to the image or the moving image inputted from the camera unit under the control of playback control command.

9. A method of playing multimedia content which can be executed in a mobile communication terminal, the method comprising the operations of:
a) sequentially reading object files included in a content file and generating frame data to be played according to playback control commands included in the content file;
b) checking whether or not an event configured to update the content has occurred;
c) when the event occurs, changing at least one of elements of a corresponding content file to a new element; and
e) outputting generated frame data.

10. The method of claim 9, wherein each of the object files is at least one of an image file, a sound file, and a moving image file.

11. The method of claim 9, wherein in the operation c), when the event occurs, at least one of elements of the content file is changed to a file which is received by accessing address information of a network resource included in the playback control command.

12. The method of claim 11, wherein when the event occurs, the operation c) for changing at least one of elements of the content file to a file which is received by accessing address information of a network resource included in the playback control command is repeated at least two times.

13. The method of claim 9, wherein in the operation c), when the event occurs, at least one of elements of the content file is changed to an image or a moving image which is input from a camera unit incorporated in the mobile communication terminal.

14. The method of claim 13, wherein the operation c) further comprises extracting a required part from the image or the moving image inputted from the camera unit so as to be suitable for an object file of interest, processing and encoding the extracted part.

15. A method of playing multimedia content which can be executed in a mobile communication terminal, the method comprising the operations of:
a) reading from a permanent storage area of a memory unit into a temporary storage area of the memory unit a content file including a header having summary information of the content, object files which are elements of the content to be played, and a playback control command, the object files being loaded into a resource area from the information included in the header, and the playback control command being read in an action area;
b) sequentially reading the object files loaded into the resource area and generating frame data to be played according to the playback control command stored in the action area;
c) checking a queue, in which events are stored, to check whether or not there is an action defined in connection with a currently generated event;
d) if there is a corresponding action, changing the content or at least one of elements of the corresponding content file, which is stored in the resource area, to a new element under the control of the playback control command included in the action; and
f) playing generated frame data.

16. The method of claim 15, after the operation d), further comprising the operation e) of substituting corresponding content or elements stored in the permanent storage area of the memory unit by the updated element of the content file.

17. The method of claim 15, wherein in the operation d), when there is a corresponding action, the content or at least one of elements of the content is changed to a corresponding content or an element of the content which is received by accessing a corresponding resource from address information of a network resource included in the playback control command.

18. The method of claim 17, wherein when a predetermined event occurs, the operation d) for changing the corresponding content file to a network resource is repeated at least two times.

19. The method of claim 15, wherein in the operation d), when there is a corresponding action, the corresponding content or at least one of elements of the content is changed to an image or a moving image which is input from a camera unit incorporated in the mobile communication terminal.

20. The method of claim 19, wherein the operation d) further comprises extracting a required part from the image or the moving image inputted from the camera unit so as to be suitable for an object file of interest, processing and encoding the extracted part.

21. A recording medium for storing multimedia content that includes a header having summary information of the content, object files constituting the content to be played, and playback control commands, wherein the playback control command comprises:
means for sequentially reading the object files related to the content to be played and generating frame data to be played;
means for checking a queue in which events are stored and checking whether or not there is an action defined in connection with a currently generated event;
means for, when there is a corresponding action, changing the content or at least one of elements of the corresponding content file, which is stored in a resource area, to a new element under the control of a playback control command included in the action; and
means for playing the generated frame data.

22. The recording medium of claim 21, wherein when there is the corresponding action, the changing means receives and updates the content or at least one of elements of the content by accessing a corresponding resource from address information of a network resource included in at least one of the playback control commands.

23. The recording medium of claim 21, wherein when there is the corresponding action, the changing means changes the corresponding content or at least one of elements of the content to an image or a moving image which is input from a camera unit incorporated in the mobile communication terminal.
